(19) United States
(12) Patent Application Publication
(10) Pub. No.: US 2011/0243163 A1
(43) Pub. Date: Oct. 6, 2011

(54) WEDGE-FACETED NONLINEAR CRYSTAL FOR HARMONIC GENERATION

(75) Inventors: Xiaoyuan Peng, Portland, OR (US); Haiwen Wang, Mountain View, CA (US)

(73) Assignee: Electro Scientific Industries, Inc., Portland, OR (US)

(21) Appl. No.: 12/753,609

(22) Filed: Apr. 2, 2010

(51) Int. Cl. G02F 1/355; G02F 1/35; G02F 1/37; H01S 3/109

(52) U.S. Cl. 372/22; 359/328; 359/329

(57) ABSTRACT

Lasers and laser systems generate different wavelengths by nonlinear sum or difference frequency conversion. A wedge-faceted nonlinear crystal compensates for the spatial walk-off phenomenon associated with critical phase matching of a nonlinear crystal in the production of harmonic laser output at peak power.

### COPYRIGHT NOTICE

© 2010 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure relates to lasers and laser systems that generate different wavelengths by nonlinear sum or difference frequency conversion and, in particular, compensation for the spatial walk-off phenomenon associated with critical phase matching of a nonlinear crystal in the production of harmonic laser output at peak power.

### BACKGROUND INFORMATION

Laser wavelength converters are in widespread use in many industrial applications. For example, laser systems performing wavelength conversion to generate green and ultraviolet (UV) laser output have been used in laser micromachining systems. Two conventional ways of accomplishing harmonic generation entail intracavity and extracavity harmonic conversion. Harmonic generation using intracavity harmonic conversion is advantageous in that it produces with high efficiency laser output with good beam quality. Power degradation and nonlinear crystal damage control are, however, of special concern in high power applications operating at shorter wavelengths. Harmonic generation using extracavity harmonic conversion is beneficial in that it extends the lifetime of the nonlinear crystal, but the harmonic conversion efficiency is lower, especially for a lower peak power laser.

A tightly focused beam, such as, for example, a laser beam with a 100 μm diameter spot size, contributes to achieving higher conversion efficiency. There are, however, competing factors affecting harmonic conversion efficiency. On one hand, the crystal length is limited because of the effect of a spatial walk-off phenomenon resulting from critical phase matching of the nonlinear crystal, and, on the other hand, the smaller beam focus, the larger the beam divergence angle in the nonlinear crystal. Moreover, the beam spot size is limited by the damage threshold of the nonlinear crystal. Improving harmonic conversion efficiency is, therefore, a challenging endeavor.

It is known that nonlinear conversion efficiency is proportional to the length of the nonlinear crystal and the square of the peak power. To achieve high conversion efficiency of nonlinear harmonic conversion for an extracavity configuration, a small spot size is used but is limited by two major factors. The first limitation is anti-reflective (AR) coating and bulk crystal material damage caused by high peak power intensity. The second limitation is that the small spot size imposes on the nonlinear crystal the spatial walk-off phenomenon, which limits the harmonic conversion efficiency and laser beam quality.

Investigations have been carried out to improve harmonic generation efficiency. U.S. Pat. No. 7,016,389 of Dudley et al. states that there are conversion efficiency benefits stemming from the high power circulating in the laser cavity in intracavity nonlinear frequency generation. FIG. 1 of Dudley shows the typical intracavity harmonic generation scheme. The efficiency of intracavity harmonic generation will, however, be lower for cases in which there is continuous-wave (CW) operation, high pulse repetition rate (more than 100 KHz), long pulse width (more than 100 ns), or higher order harmonic generation. As in extracavity conversion, a smaller spot size and longer crystal contribute to improving the harmonic conversion efficiency. A smaller spot size raises the concern of AR coating and bulk crystal material damage, and the smaller spot size and longer crystal raise the concern of spatial walk-off phenomenon.

One approach used in extracavity harmonic generation to increase harmonic conversion efficiency by keeping a high peak power intensity without damage concern and using longer crystals with reduced walk-off effect entails imparting with a cylindrical lens an elliptical shape to the laser beam so that the major axis of the elliptical laser beam is in the walk-off plane of the nonlinear crystal. There are, however, certain disadvantages with this approach. They include the apparent need for additional components to shape the laser beam. Alignment difficulties increase with addition of at least two cylindrical lenses to the optical system because a second cylindrical lens is needed to reshape the elliptical beam to a round beam. FIG. 1 is a hybrid illustration of a graph superimposed on a block diagram of a prior art laser system. The graph shows elliptical beam formation at different stages of a laser system representing a prior art implementation of third harmonic generation using a cylindrical lens system (CL1 and CL2) in an extracavity configuration. FIG. 1 shows the displacement between the x-axis and y-axis of the waist location, which eventually causes beam roundness and astigmatism issues. The solid line represents the beam radius along the x-axis, and the dashed line represents the beam radius along the y-axis. However, it is even more difficult to position a cylindrical lens in a cavity to form an elliptical beam in the nonlinear crystal and maintain a stable cavity and to provide an elliptically shaped cavity mode.

### SUMMARY OF THE DISCLOSURE

A method of performing sum or difference frequency mixing of laser beams achieves efficient harmonic conversion in the production of high peak power laser output. The method entails use of a birefringent crystalline frequency conversion medium having an entrance facet, an interior, and a length. First and second laser beams propagating along respective first and second propagation paths are directed for incidence at an entrance angle on the entrance facet of the frequency conversion medium. The first laser beam has a first wavelength and first spot shape, and the second laser beam has a second wavelength and a second spot shape. The birefringence of the frequency conversion medium contributes to divergence and overlap for an effective interaction length of the first and second propagation paths of the respective first and second laser beams as they propagate within the interior and along the length of the frequency conversion medium.

Integral birefringence compensation of the frequency conversion medium is effected by setting the entrance angle to a value that imparts ellipticity to the first and second spot shapes. This causes, in comparison to a value of the entrance angle representing normal incidence of the first and second laser beams on the entrance facet, formation of a greater effective interaction length of overlap of the first and second elliptical spot sizes of the respective diverging first and second laser beams propagating within the frequency conversion medium to perform sum or difference frequency mixing in the production of harmonic laser output at high peak power.

The birefringent crystalline frequency conversion medium is a critical phase-matched nonlinear crystal preferably of Type I or Type II. Setting the entrance angle forms a wedge-faceted nonlinear crystal that acts as a cylindrical lens to impart ellipticity to the beams propagating in the nonlinear crystal and thereby reduce the effect of the walk-off phenomenon. The wedge-faceted nonlinear crystal can be used in both intracavity and external cavity configurations of sum frequency or difference frequency generation with improved conversion efficiency. The nonlinear crystal material can be any one of LBO, BBO, KTP, CBO, CLBO, KDP, KBBF, LiNbO₃, KNbO₃, GdCOB, and RBBF. The wedge-faceted nonlinear crystal can be used for harmonic generation to get shorter wavelengths or with an optical parameter oscillator (OPO) to get longer wavelengths. The harmonic generation can be second, third, fourth, and fifth harmonic generation.

Additional aspects and advantages will be apparent from the following detailed description of preferred embodiments, which proceeds with reference to the accompanying drawings.

### BRIEF DESCRIPTION OF THE DRAWINGS

FIG. 1 is a hybrid illustration of a graph superimposed on a block diagram of a prior art laser system, the graph showing elliptical beam formation at different stages of a laser system representing a prior art implementation of third harmonic generation using a cylindrical lens system in an extracavity configuration.

FIG. 2 is a diagram of a prior art nonlinear crystal used in generating laser output with the sum or difference of the frequencies of two input laser beams.

FIG. 3 is a diagram of a wedge-faceted nonlinear crystal formed by setting an entrance facet to an entrance angle θ that effects integral birefringence compensation of the nonlinear crystal.

FIGS. 4A and 4B are diagrams showing the progressive overlap of, respectively, round spot shapes of light beams propagating through a conventional rectangular nonlinear crystal of FIG. 2 and elliptical spot shapes of light beams propagating through a wedge-faceted nonlinear crystal of FIG. 3.

FIG. 5 is a graph showing the ellipticity of a laser beam propagating in the wedge-faceted nonlinear crystal of FIG. 3 as a function of entrance angle for four refractive indices.

FIGS. 6A, 6B, and 6C are simplified block diagrams of three possible extracavity harmonic frequency conversion configurations.

FIG. 7 is a simplified block diagram of an intracavity harmonic frequency conversion configuration.

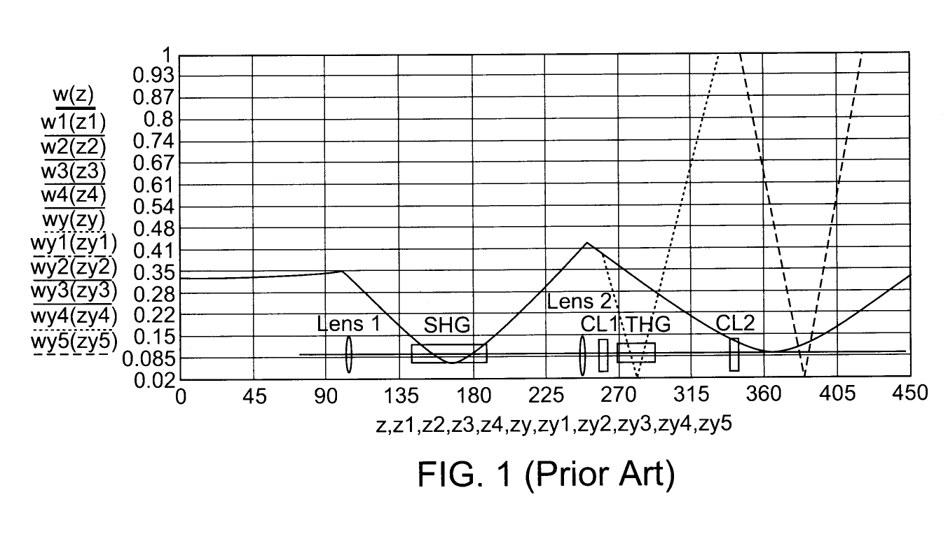

### DETAILED DESCRIPTION OF PREFERRED EMBODIMENTS

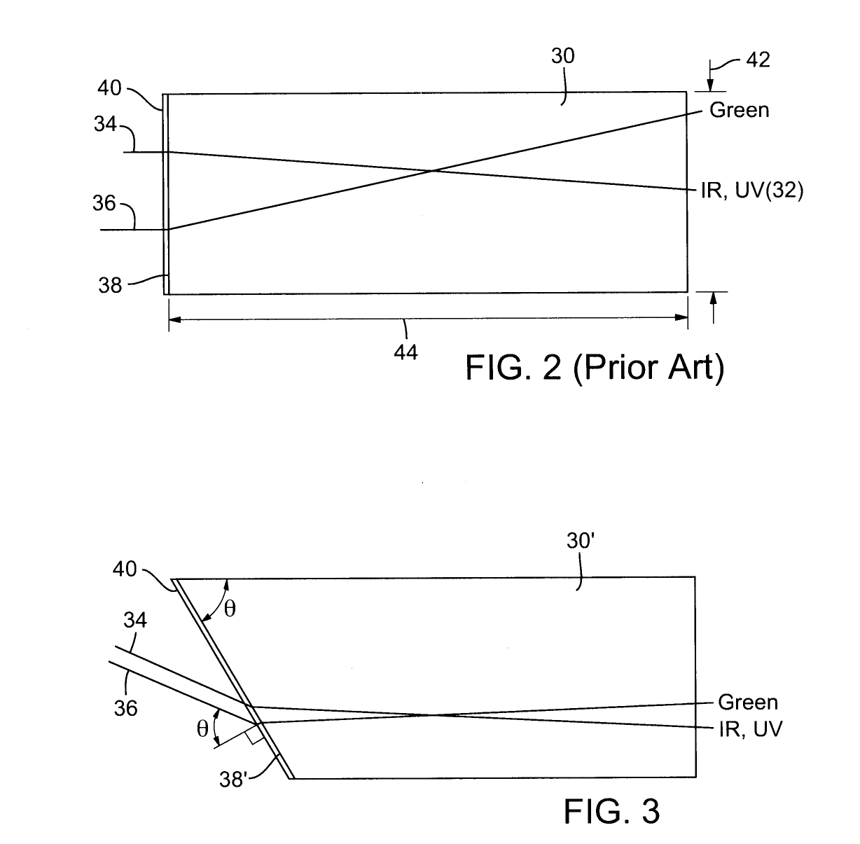

FIG. 2 is a diagram of a prior art, substantially rectangular birefringent crystalline frequency conversion medium or nonlinear crystal 30 used in generating laser output 32 with the sum or difference of the frequencies of input laser beams 34 and 36. Nonlinear crystal 30 has an entrance facet 38 covered by an anti-reflection (AR) coating 40, a width 42 of between 3 mm and 5 mm, and a length 44 of about 10 mm. Nonlinear crystal materials used in sum and difference frequency generation have refractive indices, n, typically between 1.6 and 2.0. The following description is given by way of example of sum frequency generation of 355 nm UV light output 32 by mixing infrared (IR) beam 34 of a 1064 nm Nd:YAG laser with frequency-doubled 532 nm green light beam 36.

Critical phase matching is a technique used to obtain phase matching of the nonlinear process in nonlinear crystal 30. The interacting input beams 34 and 36 are aligned at an angle relative to the axes of the refractive index ellipsoid. There is a restricted range of beam angles (called “acceptance angle”) at which critical phase matching works. Commercially available nonlinear crystals have for critical phase matching operation a nominal entrance angle that is very close to normal to the entrance surface of the crystal. Crystal phase matching is, therefore, an angular adjustment of the crystal or beam that is used to find a phase-matching configuration. Moreover, a normal incident (i.e., specified for normally incident light) AR coating 40 dictates the extent (i.e., ±10°) to which the entrance angle can depart from the surface normal before an onset of appreciable incident light reflection results in significant light transmission loss. IR beam 34 and green light beam 36 propagate parallel to each other and are incident on AR coated-entrance facet 38 at nearly normal (i.e., (90°±5°) entrance angle to achieve critical phase matching at a specified temperature.

Spatial walk-off is a phenomenon in which the intensity distribution of a beam propagating in a birefringent crystal drifts away from the propagation direction of the beam. Spatial walk-off is directly related to the acceptance angle of critical phase matching. Phase matching becomes incomplete when tightly focused beams are used, having a large beam divergence.

FIG. 3 is a diagram of a wedge-faceted nonlinear crystal 30′, which is formed by setting an entrance facet 38′ to an entrance angle θ and by changing to the same value as that of entrance angle θ the specified angle of incidence of AR coating 40 for low loss transmission. Entrance angle θ effects integral birefringence compensation of nonlinear crystal 30′. This is accomplished by setting entrance angle θ to a value that imparts ellipticity to the spot shapes of interacting input beams 34 and 36 to cause a greater effective interaction length of overlap of the elliptical spots of the diverging input beams 34 and 36.

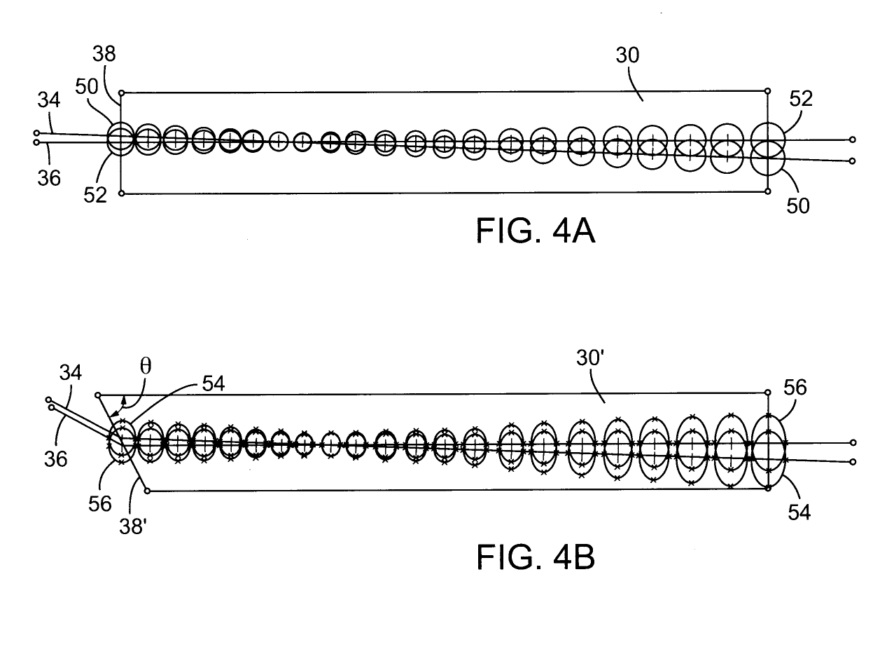

FIGS. 4A and 4B are diagrams showing the progressive overlap of, respectively, round spot shapes of light beams 34 and 36 propagating through a 20 mm-long conventional rectangular nonlinear crystal 30 of FIG. 2 and elliptical spot shapes of light beams 34 and 36 propagating through a 20 mm-long wedge-faceted nonlinear crystal 30′ of FIG. 3. FIG. 4A shows that circular spot shapes 50 and 52 of their respective light beams 34 and 36 diverge with decreasing spot overlap as they propagate along the length of nonlinear crystal 30. FIG. 4B shows that elliptical spot shapes 54 and 56 are larger along the length of nonlinear crystal 30′ than circular spot shapes 50 and 52 at corresponding locations along the length of nonlinear crystal 30, exhibit greater areas of overlap along the length of nonlinear crystal 30′ than circular spot shapes 50 and 52 exhibit at corresponding locations along the length of nonlinear crystal 30, and occupy a greater portion of the interior of nonlinear crystal 30′ than circular spot shapes 50 and 52 occupy in the interior of nonlinear crystal 30. The ellipticity of spot shapes 54 and 56 causes, therefore, a greater effective interaction length of overlap as compared to that of spot shapes 50 and 52 of beams 34 and 36 propagating through nonlinear crystal 30 of FIG. 2.

The smaller overlap of circular spot shapes 50 and 52 of laser beams exiting nonlinear crystal 30 produces higher order laser modes resulting in laser output that departs from a Gaussian shape. The greater overlap of elliptical spot shapes 54 and 56 results in laser output more closely of Gaussian shape.

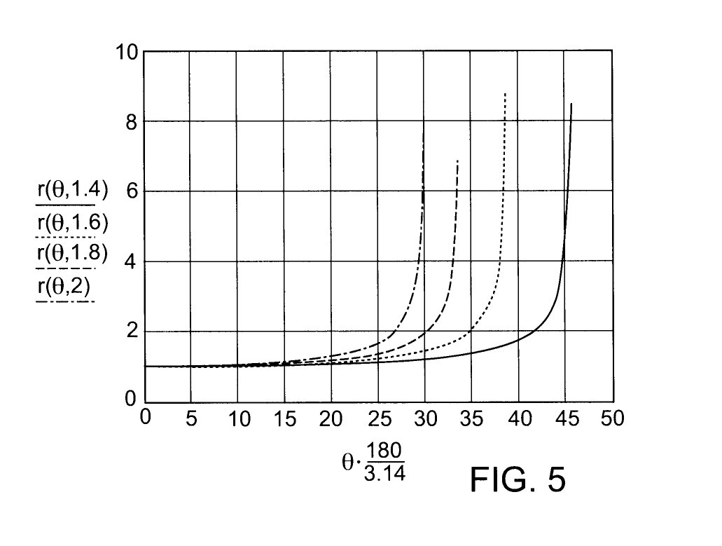

FIG. 5 is graph showing the ellipticity of laser beam 34 propagating in wedge-faceted nonlinear crystal 30′ as a function of entrance angle 30 for four refractive indices, n, equal to 1.4, 1.6, 1.8, and 2.0. FIG. 5 indicates that a larger entrance angle θ imparts to an input laser beam greater eccentricity of its elliptical spot shape. For each selected combination of pulse repetition rate, pulse width, and average power, there can be determined an optimal combination of the spot shape of the input beam, nonlinear crystal length, walk-off angle, and entrance angle θ. The entrance angle θ is operationally effective for any wavelength of incident light beam. FIG. 5 reveals that an entrance angle θ of greater than about 10° and preferably between about 10° and about 40° provides an advantageous greater effective interaction length. Because of the reduced walk-off effect, higher harmonic conversion efficiency and higher beam quality can be achieved with a smaller laser spot size and longer nonlinear crystal.

An experiment comparing the disclosed and prior art methods of harmonic conversion was performed using two LBO crystals of 20 mm length. One of the LBO crystals was of the conventional rectangular shape shown in FIG. 2, and the other LBO crystal had a wedge-faceted entrance surface with a 0.47 rad angle (27°). Green and IR light beams of 10 KW peak power incident on the LBO crystals produced UV output at 2 KW peak power for the conventional LBO crystal and UV output at 3.6 KW peak power for the wedge-faceted LBO crystal. Practice of the disclosed method results, therefore, in an increase of harmonic conversion efficiency from 20% to 36%.

Harmonic frequency conversion implemented with a wedge-faceted nonlinear crystal can be configured in either external cavity structure or intracavity structure. The nonlinear crystal material can be of Type I or II, and the frequency conversion can be either sum frequency or difference frequency. The nonlinear crystal can be any one of BBO, LBO, CBO, CLBO, KBBF, RBBF, KTP, LiNbO₃, KNbO₃, GdCOB, and BIBO.

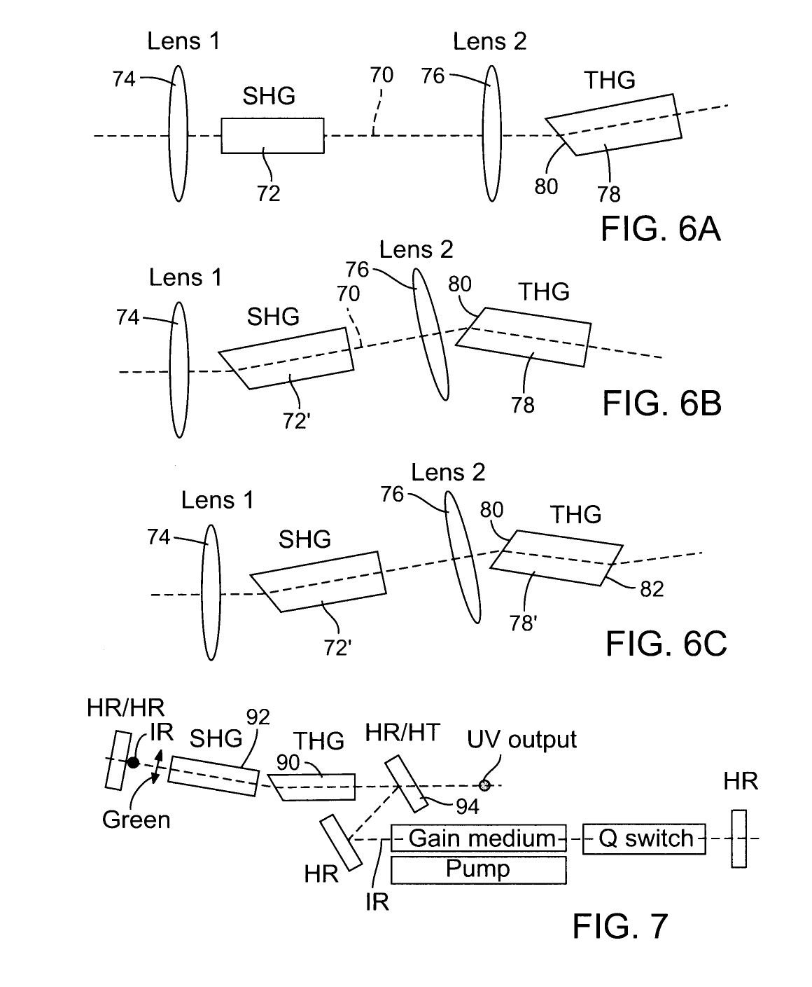

FIGS. 6A, 6B, and 6C are simplified block diagrams of three possible extracavity harmonic frequency conversion configurations. FIG. 6A shows, set in optical series along an optical axis 70, optical components including a conventional nonlinear crystal second harmonic generator (SHG) 72 positioned between a first focusing lens 74 and a second focusing lens 76. A third harmonic generator (THG) 78 is positioned adjacent the exit surface of second focusing lens 76. THG 78 has a wedge-faceted entrance surface 80 that reduces the spatial walk-off effect. FIG. 6B shows a set of optical components that are similar to those of FIG. 6A, except that a wedge-faceted nonlinear crystal SHG 72′ replaces conventional nonlinear crystal 72 and the surface angle of wedge-faceted entrance surface 80 of THG 78 is different. FIG. 6B demonstrates that both SHG and THG nonlinear crystals can have wedge-faceted entrance surfaces to reduce the spatial walk-off effect. FIG. 6C shows the same set of optical components as those of FIG. 6B, except that a nonlinear crystal THG 78′ replaces nonlinear crystal THG 78 to provide, together with wedge-faceted entrance surface 80, a wedge-faceted exit surface 82 to reshape the elliptical beam to a round beam and thereby eliminate need for a cylindrical lens.

FIG. 7 is a simplified block diagram of an intracavity harmonic frequency conversion configuration. A wedge-faceted nonlinear crystal 90 is positioned between a conventional nonlinear crystal SHG 92 and an output coupler 94. Especially for intracavity third harmonic generation at high pulse repetition rate and low peak power, the conversion efficiency is proportional to the length of wedge-faceted nonlinear crystal 90. For harmonic frequency conversion using a wedge-faceted nonlinear crystal, when the focused beam spot size is 100 μm, one can design a longer than 20 mm wedge-faceted LBO crystal (˜0.47 rad) with much reduced walk-off effect; while for a conventional LBO crystal of rectangular shape under the same operating conditions, the maximum length of the crystal is 10 mm. Therefore one can expect higher efficiency by practicing the disclosed method.

It will be obvious to those having skill in the art that many changes may be made to the details of the above-described embodiments without departing from the underlying principles of the invention. The scope of the present invention should, therefore, be determined only by the following claims.

1. A method of performing sum or difference frequency mixing of laser beams to achieve efficient harmonic conversion in the production of high peak power laser output, comprising:
providing a birefringent crystalline frequency conversion medium having an entrance facet, an interior, and a length;
directing for incidence at an entrance angle on the entrance facet of the frequency conversion medium first and second laser beams propagating along respective first and second propagation paths, the first laser beam having a first wavelength and first spot shape and the second laser beam having a second wavelength and a second spot shape, and the birefringence of the frequency conversion medium contributing to divergence and overlap for an effective interaction length of the first and second propagation paths of the respective first and second laser beams as they propagate within the interior and along the length of the frequency conversion medium; and
effecting integral birefringence compensation of the frequency conversion medium by setting the entrance angle to a value that imparts ellipticity to the first and second spot shapes and thereby causes, in comparison to a value of the entrance angle representing normal incidence of the first and second laser beams on the entrance facet, a greater effective interaction length of overlap of the first and second elliptical spot sizes of the respective diverging first and second laser beams propagating within the frequency conversion medium to perform sum or difference frequency mixing in the production of harmonic laser output at high peak power.

2. The method of claim 1, in which the birefringent crystalline frequency conversion medium is a critical phase-matched nonlinear crystal of Type I or Type II.

3. The method of claim 2, in which the critical phase-matched nonlinear crystal includes LBO, BBO, KTP, CBO, CLBO, KDP, KBBF, LiNbO₃, KNbO₃, GdCOB, or RBBF.

4. The method of claim 1, in which the birefringent crystalline frequency conversion medium is a critical phase-matched nonlinear crystal and in which the entrance angle is set to a value that forms a wedge-faceted nonlinear crystal.

5. The method of claim 1, in which the production of harmonic laser output includes second, third, fourth, or fifth harmonic generation.

6. The method of claim 1, in which the birefringent crystalline frequency conversion medium is a critical phase-matched nonlinear crystal that is a component of an extracavity laser system configuration.

7. The method of claim 1, in which the birefringent crystalline frequency conversion medium is a critical phase-matched nonlinear crystal that is a component of an intracavity laser system configuration.

8. The method of claim 1, in which the value of the entrance angle is not less than about 10°.

9. The method of claim 8, in which the value of the entrance angle is between about 10° and about 40°.

10. The method of claim 1, in which the birefringent crystalline frequency conversion medium has an exit facet, and the exit facet is set to an exit angle of a value that compensates for the ellipticity imparted by the entrance angle and thereby produces the harmonic laser output with a round beam spot size.
